(19) United States
(12) Patent Application Publication
(10) Pub. No.: US 2005/0028676 A1
(43) Pub. Date: Feb. 10, 2005

(54) Corona discharge electrode assembly for electrostatic precipitator

(76) Inventors: Scott P. Heckel, Stoughton, WI (US); Gregory W. Hoverson, Cookeville, TN (US); Stephen L. Fallon, Madison, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/634,565

(22) Filed: Aug. 5, 2003

(51) Int. Cl. B03C 3/41

(52) U.S. Cl. 96/95

(57) ABSTRACT

A corona discharge electrode assembly is provided for an electrostatic precipitator, including for a diesel engine electrostatic crankcase ventilation system for blowby gas, having a collector electrode spaced from a discharge electrode by a gap to facilitate corona discharge therebetween. The corona discharge electrode assembly includes a drum having strips, louvers or spikes providing corona discharge tips.

### BACKGROUND AND SUMMARY

The invention relates to electrostatic precipitators, including for diesel engine electrostatic crankcase ventilation systems for blowby gas for removing suspended particulate matter including oil droplets from the blowby gas.

Electrostatic precipitators, including for diesel engine electrostatic crankcase ventilation systems, are known in the prior art. In its simplest form, a high voltage corona discharge electrode is placed in the center of a grounded tube or canister forming an annular ground plane providing a collector electrode around the discharge electrode. A high DC voltage, such as several thousand volts, e.g. 15 kV, on the center discharge electrode causes a corona discharge to develop between the discharge electrode and the interior surface or wall of the tube providing the collector electrode. As the gas containing suspended particles flows between the discharge electrode and the collector electrode, the particles are electrically charged by the corona ions. The charged particles are then precipitated electrostatically by the electric field onto the interior surface of the collecting tube.

Electrostatic precipitators have been used in diesel engine crankcase ventilation systems for removing suspended particulate matter including oil droplets from the blowby gas, for example so that the blowby gas can be returned to the fresh air intake side of the diesel engine for further combustion, thus providing a blowby gas recirculation system.

The corona discharge electrode assembly as currently used in the prior art has a holder or bobbin with a 0.006 inch diameter wire strung in a diagonal direction. The bobbin is provided by a central drum extending along an axis and having a pair of annular flanges axially spaced along the drum and extending radially outwardly therefrom. The wire is a continuous member strung back and forth between the annular flanges to provide a plurality of segments supported by and extending between the annular flanges and strung axially and partially spirally diagonally between the annular flanges. A drawback of this design is that the wires prematurely break in one or more locations, degrading the performance of the electrostatic precipitator collector, reducing efficiency to zero, and limiting the life of the unit. A manufacturing drawback is that the small diameter wire with relatively low strength makes the stringing of the wire on the noted flanges a challenging task.

The present invention addresses and solves the above noted problems. The invention provides increased mechanical strength of the discharge electrode assembly, longer life, and more cost effective manufacturability. The invention provides longer electrode life by improving electrode erosion tolerance and mechanical strength for vibration and fatigue resistance.

### BRIEF DESCRIPTION OF THE DRAWINGS

Prior Art

FIG. 1 illustrates a corona discharge electrode assembly known in the prior art.

Present Invention

FIG. 2 is like FIG. 1 and illustrates the present invention.

FIG. 3 is like FIG. 2 and shows another embodiment.

FIG. 4 is like FIG. 2 and shows another embodiment.

FIG. 5 is like FIG. 2 and shows another embodiment.

FIG. 6 shows an electrode edge configuration.

FIG. 7 is like FIG. 6 and shows another embodiment.

FIG. 8 is like FIG. 6 and shows another embodiment.

FIG. 9 is like FIG. 6 and shows another embodiment.

FIG. 10 is like FIG. 6 and shows another embodiment.

FIG. 11 is like FIG. 6 and shows another embodiment.

FIG. 12 illustrates another discharge electrode assembly in accordance with invention.

FIG. 13 is like FIG. 12 and shows another embodiment.

FIG. 14 is like FIG. 12 and shows another embodiment.

### DETAILED DESCRIPTION

Prior Art

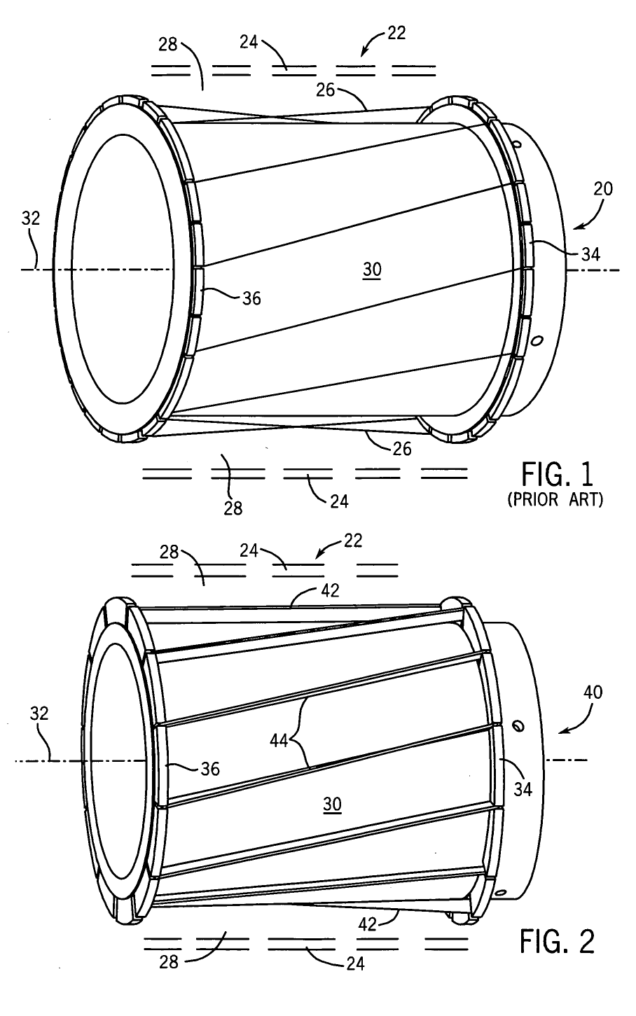

FIG. 1 shows a corona discharge electrode assembly 20 for an electrostatic precipitator 22 having an outer cylindrical housing or can shown in dashed line at 24 which is a grounded tube or canister forming an annular ground plane providing a collector electrode spaced from a discharge electrode 26 by a gap 28 to facilitate corona discharge therebetween, all as is known, for example U.S. Pat. No. 6,221,136, incorporated herein by reference. Corona discharge assembly 20 includes an electrically insulating central drum or bobbin 30, e.g. plastic, extending along an axis 32 and having a pair of annular flanges 34 and 36 axially spaced along the drum and extending radially outwardly from the drum. Discharge electrode 26 is an electrically conductive wire strung back and forth between annular flanges 34, 36 to have a plurality of segments strung axially and partially spirally diagonally between annular flanges 34, 36. Particulate matter, including oil droplets from blowby gas in the case of diesel engine exhaust, flows axially through annular gap 28 for removal of suspended particulate matter including oil droplets by electrostatic precipitation, as noted above, and as is known.

Present Invention

FIGS. 2-14 show the present invention and use like reference numerals from above where appropriate to facilitate understanding.

FIG. 2 shows a corona discharge electrode assembly 40 for electrostatic precipitator 22 having collector electrode 24 spaced from discharge electrode 42 by gap 28 to facilitate corona discharge therebetween. Corona discharge electrode assembly 40 includes electrically insulating plastic central drum 30 extending along axis 32 and having annular flanges 34, 36 axially spaced along the drum and extending radially outwardly from the drum. An electrically conductive strip or tape 42 has a plurality of segments 44 supported by and extending between annular flanges 34, 36. Segments 42 have a length dimension extending axially and diagonally between annular flanges 34, 36, a height dimension extending radially relative to drum 30, and a width dimension extending normal to the length dimension and to the height dimension. FIG. 2 substitutes a flat strip of metal 42 for the wire 26 of FIG. 1. The noted height dimension of segments 44 of strip 42 is substantially less than the noted length dimension and substantially greater than the noted width dimension. The noted height dimension should preferably be in the range from 0.01 to 0.5 inch, and the noted width dimension in the range 0.001 to 0.01 inch. In one preferred embodiment, the noted height dimension is 0.25 inch, and the noted width dimension is 0.006 inch, and the cross-sectional area of segment 44 along the noted width dimension and the noted height dimension is 53 times greater than the cross-sectional area of discharge electrode wire 26 of FIG. 1. In another embodiment which appears promising, the height dimension is 0.25 inch, and the width dimension is 0.002 inch. It is anticipated that further optimization will occur during continuing development. Strip 42 is a continuous member strung back and forth between annular flanges 34, 36, wherein segments 44 are strung axially and partially spirally diagonally between the annular flanges.

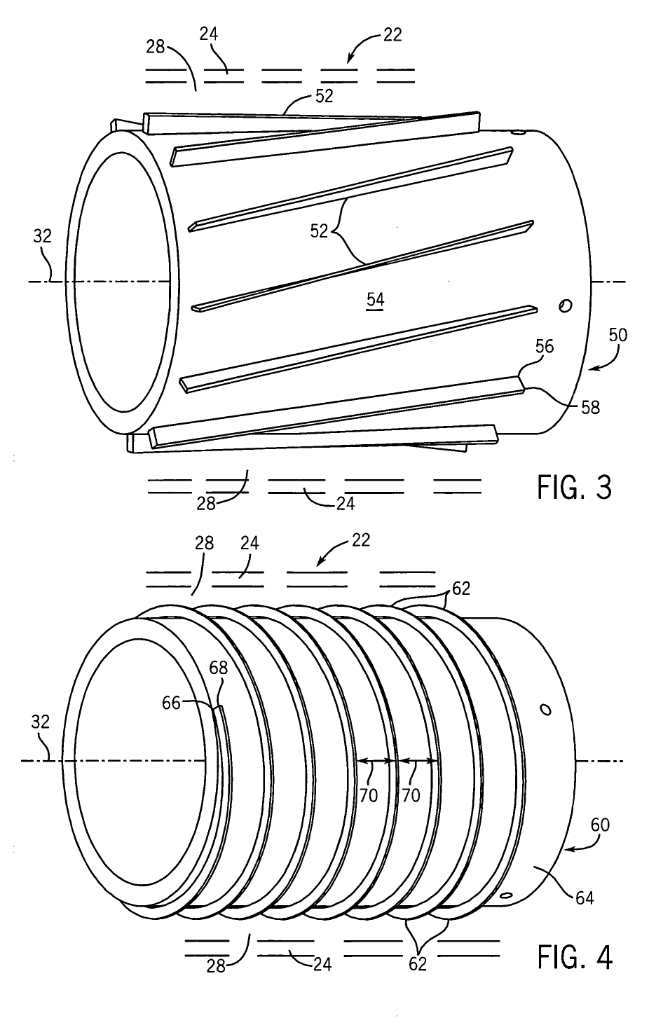

FIG. 3 shows a corona discharge electrode assembly 50 for electrostatic precipitator 22 having collector electrode 24 spaced from a discharge electrode 52 by gap 28 to facilitate corona discharge therebetween. Corona discharge electrode assembly 50 includes central drum 54 extending along axis 32 and having a plurality of electrically conductive strips 52 each having a length dimension extending axially and preferably diagonally along and mounted to the drum, a height dimension extending radially relative to the drum, and a width dimension extending normal to the length dimension and to the height dimension. The height dimension is substantially less than the length dimension and substantially greater than the width dimension. In one form, drum 54 is an electrically insulating member, e.g. plastic, and strips or blades 52 are mechanically inserted in the drum or insert molded therein. The strips have a base 56 at the drum, and extend radially outwardly therefrom along the noted height dimension to an outer tip 58. The strips have a first width at the base 56, and a second width at the outer tip 58. Preferably, the noted first width is greater than the noted second width, and further preferably, outer tip 58 is a knife edge, and the noted second width is substantially less than the first width. The knife edge facilitates corona discharge to the outer annular ground plane providing collector electrode 24. The wider base 56 allows the use of much larger cross sections and improved mechanical strength and tolerance to erosion. The requirement to string a wire or strip is eliminated. In preferred form, strips 52 extend axially and partially spirally diagonally along drum 54.

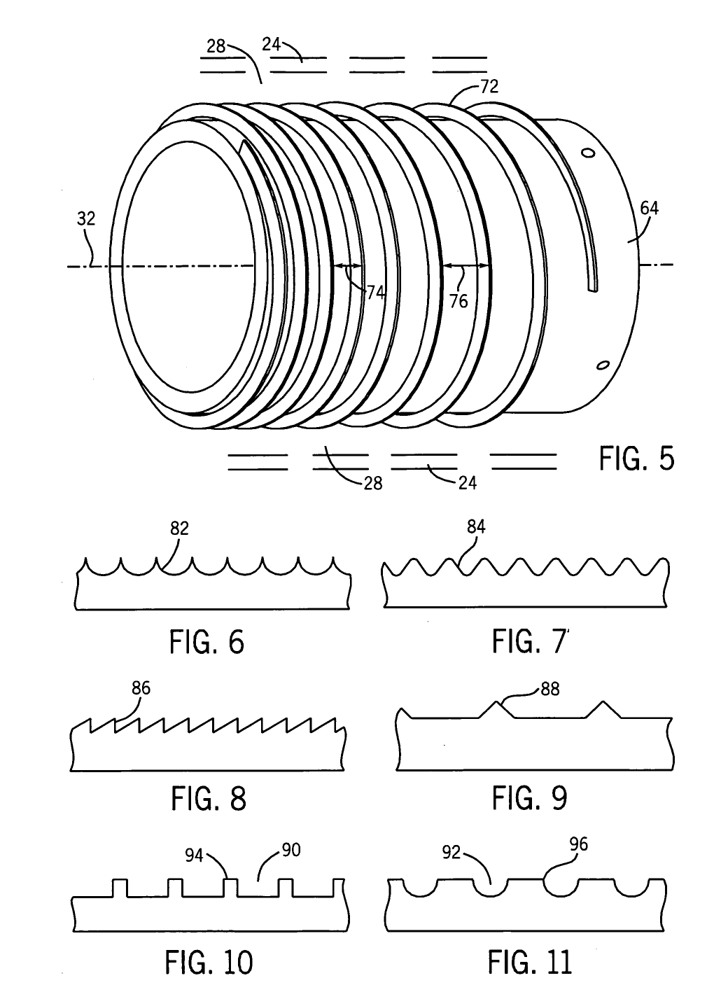

FIG. 4 shows a corona discharge electrode assembly 60 for electrostatic precipitator 22 having collector electrode 24 spaced from a discharge electrode 62 by gap 28 to facilitate corona discharge therebetween. Corona discharge electrode assembly 60 includes central drum 64 extending along axis 32 and having an electrically conductive strip 62 wound in a helix around the drum. Strip 62 has a length dimension extending helically around the drum, a height dimension extending radially relative to the drum, and a width dimension extending normal to the length dimension and to the height dimension. The height dimension is substantially less than the length dimension and substantially greater than the width dimension. Strip 62 has a base 66 at the drum and extends radially outwardly therefrom along the noted height dimension to an outer tip 68, and has a first width at base 66, and a second width at outer tip 68. The first width is greater than the second width, and preferably outer tip 68 is a knife edge and the second width is substantially less than the first width. In FIG. 4, the helix has a constant pitch to provide equal axial spacing 70 of helical segments of the strip along the drum. In FIG. 5, electrically conductive strip 72 is wound in a helix of variable pitch around drum 64, to provide unequal axial spacing 74, 76 of helical segments of strip 72 along the drum.

Strips 42, 52, 62, 72 have a corona discharge outer edge at outer tips 58, 68, etc. facing collector electrode 24 across gap 28. In further embodiments, such edge is shaped to provide a plurality of corona discharge locations along the strip for corona discharge to the collector electrode. In FIG. 6, the discharge edge is serrated as shown at 82. In FIG. 7, the discharge edge is wave-shaped as shown at 84, preferably sinusoidal. In FIG. 8, the discharge edge is sawtoothed-shaped as shown at 86. The discharge edge has a plurality of detents therealong, which may or may not be periodic, and which protrude outwardly as shown at 88 in FIG. 9 from the discharge edge toward the collector electrode and/or are recessed inwardly as shown at 90 in FIG. 10 and 92 in FIG. 11 from the discharge edge away from the collector electrode leaving corona discharge tips 94, FIG. 10, 96, FIG. 11 at the junctions of the edge and the detents. In FIG. 8, the detents are triangular cuts. In FIG. 10, the detents are rectangular cuts. In FIG. 11, the detents are arcuate or circular cuts. The above noted knife edge outer tip discharge edge and the noted edge shaping of FIGS. 6-11 to control the locations along the edge where corona discharge occurs can be used to reduce the corona onset voltage if desired.

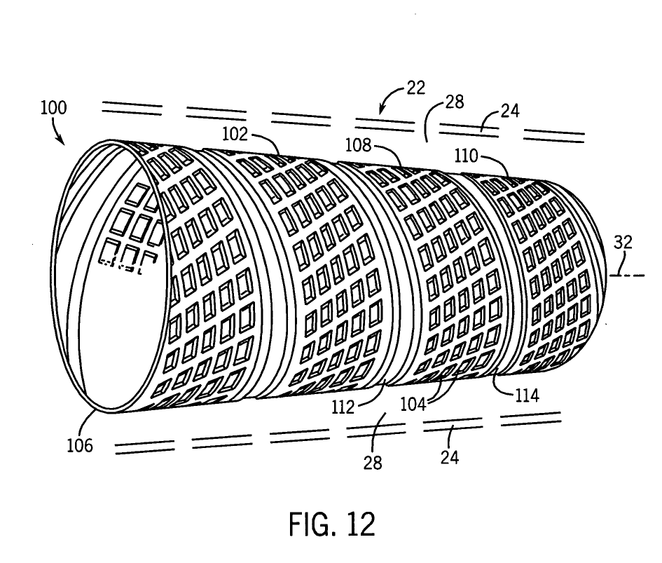

FIG. 12 shows a corona discharge electrode assembly 100 for electrostatic precipitator 22 having collector electrode 24 spaced from a discharge electrode 102 by gap 28 to facilitate corona discharge therebetween. Corona discharge electrode assembly 100 includes an electrically conductive louvered drum 102 having louvers 104 providing a plurality of corona discharge locations along the drum for corona discharge to collector electrode 24. Drum 102 has a drum wall 106, and the louvers are provided by a plurality of perforations at 104 through the drum wall. Perforations 104 form a plurality of corona discharge tips at the junctions of the drum and the perforations for corona discharge across gap 28 to collector electrode 24. The perforations can have various shapes. Drum 102 extends along axis 32 and is provided by a spiral wound sheet having helical sections 108, 110, etc. joined by axially spaced joints 112, 114, etc. having perforations 104 therebetween providing the louvers between such joints 112, 114, etc.

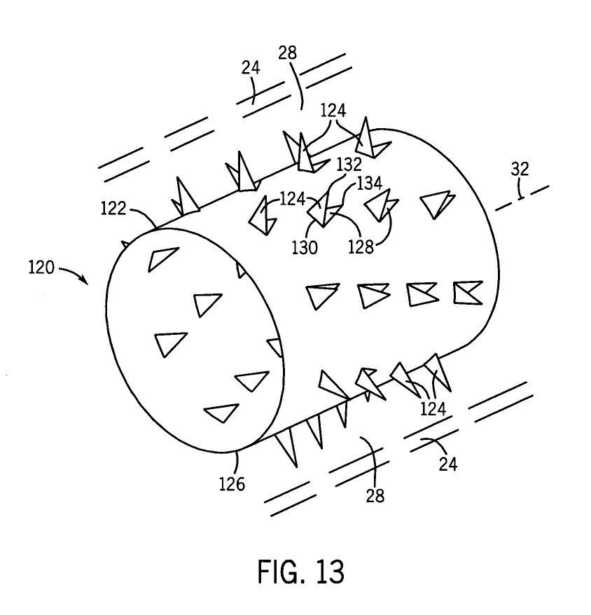

FIG. 13 shows a corona discharge electrode assembly 120 for electrostatic precipitator 22 having collector electrode 24 spaced from a discharge electrode 122 by gap 28 to facilitate corona discharge therebetween. Corona discharge electrode assembly 120 includes an electrically conductive louvered drum 122 having louvers 124 providing a plurality of corona discharge locations along the drum for corona discharge to collector electrode 24. The drum has a drum wall 126, and the louvers are provided by a plurality of perforations 128 through the drum wall providing a plurality of flaps at 124 extending from the drum toward collector electrode 24. Each flap has a base 130 at the junction of drum wall 126 and a respective perforation 128, and has an outer tip 132 spaced from collector electrode 24 across gap 28. Each flap comprises a portion of drum wall 126, such portion being cut by the respective perforation 128, the portion being bent away from the drum and toward collector electrode 24 along a bend line at junction 130 of drum wall 126 and the respective perforation 128. Outer tip 132 is pointed, and the respective perforation 128 has a perforation tip 134 distally opposite the bend line at junction 130, the perforation tip 134 being complimentary to pointed outer tip 132 of flap 124. In the embodiment of FIG. 13, flap 124 and perforation 128 are of identical triangular shape.

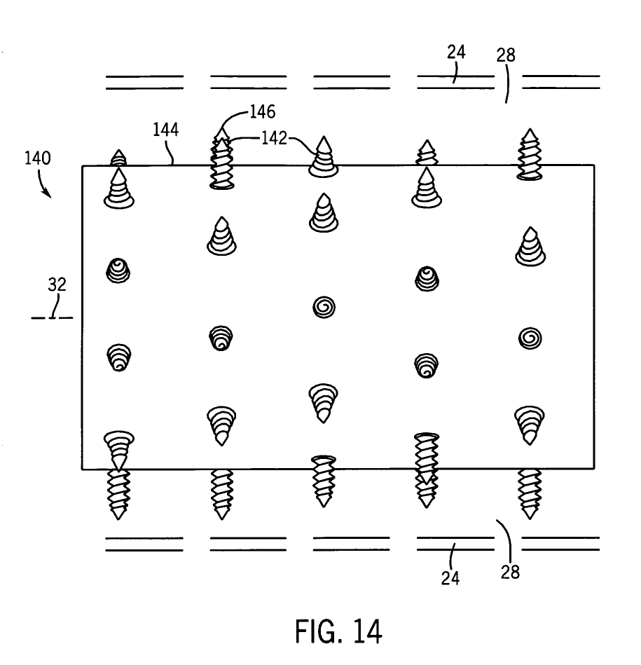

FIG. 14 shows a corona discharge electrode assembly 140 for electrostatic precipitator 22 having collector electrode 24 spaced from a discharge electrode 142 by gap 28 to facilitate corona discharge therebetween. Corona discharge electrode assembly 140 includes a central drum 144 extending along axis 32 and having a plurality of electrically conductive spikes 142 extending radially therefrom to provide a plurality of corona discharge tips 146 spaced from collector electrode 24 by gap 28. This embodiment uses plural point projections, helping keep corona onset voltage low if desired.

The embodiment of FIG. 2 was comparatively tested against the prior art shown in FIG. 1 for a comparison of efficiency. Testing was performed with corona current regulated at 0.75 milliamps. Both units were able to produce 0.75 milliamps of corona current within the typical 16 kV voltage limit. This is a significant finding because both systems produce a similar amount of charged ions. The strip or tape 42 in FIG. 2 was 301 Stainless Steel, 0.006 inch width dimension, 0.25 inch height dimension. Wire 26 in FIG. 1 was 304 Stainless Steel, 0.006 inch diameter. Efficiency tests were run for 2 hours on a Cummins ISL engine at full engine load, namely 1,100 foot pounds torque at 2,000 RPM, and resulted in an average efficiency of 98% for the embodiment of FIG. 2, and 98% for the prior art of FIG. 1. These results indicate that the embodiment of FIG. 2 suffers no performance loss compared to the prior art of FIG. 1.

The embodiment of FIG. 12 was tested against the standard corona wire design of FIG. 1 to compare efficiency. Testing was performed with the corona current set at 1 milliamp. This current was achieved within 16 kV. Drum 102 had a 0.016 inch thick drum wall 106, an axial length of 4 inches, and a gap 28 of 0.5 inch. The efficiency test was run for 2 hours on a Cummins ISL engine at 1,100 foot pounds torque at 2,000 RPM, resulting in a 92% efficiency. This efficiency was lower than the embodiment of FIG. 1. It is anticipated that decreasing the thickness of the drum wall to 0.006 inch or less will increase the efficiency due to improved corona generation.

Testing was performed on the embodiment of FIG. 14 for 2 hours on a Cummins ISL engine at 1,100 foot pounds torque at 2,000 RPM, resulting in a 97.7% efficiency with 0.75 milliamps corona current at a reduced voltage of 12 kV, which is lower than the standard corona wire design of FIG. 1. This is considered desirable to enable lower voltage requirements.

It is recognized that various equivalents, alternatives and modifications are possible within the scope of the appended claims.

1. A corona discharge electrode assembly for an electrostatic precipitator having a collector electrode spaced from a discharge electrode by a gap to facilitate corona discharge therebetween, said corona discharge electrode assembly comprising a drum extending along an axis and having a pair of annular flanges axially spaced along said drum and extending radially outwardly from said drum, and an electrically conductive strip having a plurality of segments supported by and extending between said annular flanges, said segments having a length dimension extending axially between said annular flanges, a height dimension extending radially relative to said drum, and a width dimension extending normal to said length dimension and to said height dimension, wherein said height dimension is substantially less than said length dimension and substantially greater than said width dimension.

2. The corona discharge electrode assembly according to claim 1 wherein the cross-sectional area of said segments along said width dimension and said height dimension is on the order of 50 times greater than a discharge electrode of wire segments.

3. The corona discharge electrode assembly according to claim 2 wherein said height dimension is in the range of 0.1 to 0.5 inch, and said width dimension is in the range of 0.001 to 0.02 inch.

4. The corona discharge electrode assembly according to claim 1 wherein said strip is a continuous member strung back and forth between said annular flanges.

5. The corona discharge electrode assembly according to claim 4 wherein said segments are strung axially and partially spirally diagonally between said annular flanges.

6. A corona discharge electrode assembly for an electrostatic precipitator having a collector electrode spaced from a discharge electrode by a gap to facilitate corona discharge therebetween, said corona discharge electrode assembly comprising a drum extending along an axis and having a plurality of electrically conductive strips each having a length dimension extending axially along and mounted to said drum, a height dimension extending radially relative to said drum, and a width dimension extending normal to said length dimension and to said height dimension, wherein said height dimension is substantially less than said length dimension and substantially greater than said width dimension.

7. The corona discharge electrode assembly according to claim 6 wherein said strips have a base at said drum, and extend radially outwardly therefrom along said height dimension to an outer tip, and have a first width at said base, and a second width at said outer tip, wherein said first width is greater than said second width.

8. The corona discharge electrode assembly according to claim 7 wherein said outer tip is a knife edge, and said second width is substantially less than said first width.

9. The corona discharge electrode assembly according to claim 6 wherein said strips extend axially and partially spirally diagonally along said drum.

10. A corona discharge electrode assembly for an electrostatic precipitator having a collector electrode spaced from a discharge electrode by a gap to facilitate corona discharge therebetween, said corona discharge electrode assembly comprising a drum extending along an axis and having an electrically conductive strip wound in a helix around said drum.

11. The corona discharge electrode assembly according to claim 10 wherein said strip has a length dimension extending helically around said drum, a height dimension extending radially relative to said drum, and a width dimension extending normal to said length dimension and to said height dimension, wherein said height dimension is substantially less than said length dimension and substantially greater than said width dimension.

12. The corona discharge electrode assembly according to claim 11 wherein said strip has a base at said drum, and extends radially outwardly therefrom along said height dimension to an outer tip, and has a first width at said base, and a second width at said outer tip, wherein said first width is greater than said second width.

13. The corona discharge electrode assembly according to claim 12 wherein said outer tip is a knife edge, and said second width is substantially less than said first width.

14. The corona discharge electrode assembly according to claim 10 wherein said helix has a constant pitch to provide equal axial spacing of helical segments of said strip along said drum.

15. The corona discharge electrode assembly according to claim 10 wherein said helix has a variable pitch to provide unequal axial spacing of helical segments of said strip along said drum.

16. A corona discharge electrode assembly for an electrostatic precipitator having a collector electrode spaced from a discharge electrode by a gap to facilitate corona discharge therebetween, said corona discharge electrode assembly comprising a drum supporting an electrically conductive strip having a corona discharge edge facing said collector electrode across said gap, said edge being shaped to provide a plurality of corona discharge locations along said strip for corona discharge to said collector electrode.

17. The corona discharge electrode assembly according to claim 16 wherein said edge is serrated.

18. The corona discharge electrode assembly according to claim 16 wherein said edge is wave-shaped.

19. The corona discharge electrode assembly according to claim 18 wherein said edge is sinusoidal.

20. The corona discharge electrode assembly according to claim 16 wherein said edge is sawtooth-shaped.

21. The corona discharge electrode assembly according to claim 16 wherein said edge has a plurality of detents therealong.

22. The corona discharge electrode assembly according to claim 21 wherein said detents are periodic.

23. The corona discharge electrode assembly according to claim 21 wherein said detents protrude outwardly from said edge toward said collector electrode.

24. The corona discharge electrode assembly according to claim 21 wherein said detents are recessed inwardly from said edge away from said collector electrode leaving corona discharge tips at the junctions of said edge and said detents.

25. The corona discharge electrode assembly according to claim 24 wherein said detents are triangular cuts.

26. The corona discharge electrode assembly according to claim 24 wherein said detents are rectangular cuts.

27. The corona discharge electrode assembly according to claim 24 wherein said detents are arcuate cuts.

28. The corona discharge electrode assembly according to claim 16 wherein said drum extends along an axis and has a pair of annular flanges axially spaced along said drum and extending radially outwardly from said drum, and wherein said electrically conductive strip has a plurality of segments supported by and extending between said annular flanges, said segments having a length dimension extending axially between said annular flanges, a height dimension extending radially relative to said drum, and a width dimension extending normal to said length dimension and to said height dimension, wherein said height dimension is substantially less than said length dimension and substantially greater than said width dimension, and wherein said edge extends along said length dimension and said width dimension.

29. The corona discharge electrode assembly according to claim 16 wherein said drum extends along an axis, and said electrically conductive strip comprises a plurality of electrically conductive strips each having a length dimension extending axially along and mounted to said drum, a height dimension extending radially relative to said drum, and a width dimension extending normal to said length dimension and to said height dimension, wherein said height dimension is substantially less than said length dimension and substantially greater than said width dimension, and wherein said edge extends along said length dimension and said width dimension.

30. The corona discharge electrode assembly according to claim 16 wherein said drum extends along an axis, and said electrically conductive strip is wound in a helix around said drum, wherein said strip has a length dimension extending helically around said drum, a height dimension extending radially relative to said drum, and a width dimension extending normal to said length dimension and to said height dimension, wherein said height dimension is substantially less than said length dimension and substantially greater than said width dimension, and wherein said edge extends along said length dimension and said width dimension.

31. A corona discharge electrode assembly for an electrostatic precipitator having a collector electrode spaced from a discharge electrode by a gap to facilitate corona discharge therebetween, said corona discharge electrode assembly comprising an electrically conductive louvered drum having louvers providing a plurality of corona discharge locations along said drum for corona discharge to said collector electrode.

32. The corona discharge electrode assembly according to claim 31 wherein said drum has a drum wall, and said louvers are provided by a plurality of perforations through said drum wall.

33. The corona discharge electrode assembly according to claim 32 wherein said perforations form a plurality of corona discharge tips at the junctions of said drum and said perforations for corona discharge across said gap to said collector electrode.

34. The corona discharge electrode assembly according to claim 33 wherein said drum extends along an axis and comprises a spiral wound sheet having helical sections joined by axially spaced joints having said perforations therebetween providing said louvers between said joints.

35. The corona discharge electrode assembly according to claim 32 comprising a plurality of flaps extending from said drum toward said collector electrode.

36. The corona discharge electrode assembly according to claim 35 wherein each said flap has a base at the junction of said drum wall and a respective said perforation, and has an outer tip spaced from said collector electrode across said gap.

37. The corona discharge electrode assembly according to claim 36 wherein each said flap comprises a portion of said drum wall, said portion being cut by said perforation, wherein said portion is bent away from said drum and toward said collector electrode along a bend line at said junction of said drum wall and said respective perforation.

38. The corona discharge electrode assembly according to claim 37 wherein said outer tip is pointed, and wherein said respective perforation has a perforation tip distally opposite said bend line at said junction, said perforation tip being complimentary to said pointed outer tip of said flap.

39. The corona discharge electrode assembly according to claim 38 wherein said flap and said respective perforation are of identical triangular shape.

40. A corona discharge electrode assembly for an electrostatic precipitator having a collector electrode spaced from a discharge electrode by a gap to facilitate corona discharge therebetween, said corona discharge electrode assembly comprising a drum extending along an axis and having a plurality of electrically conductive spikes extending radially therefrom to provide a plurality of corona discharge tips spaced from said collector electrode by said gap.
